(19) United States
(12) Patent Application Publication
(10) Pub. No.: US 2018/0012674 A1
(43) Pub. Date: Jan. 11, 2018

(54) Heat Keeping Structure

(71) Applicant: Yeh-Hsun Wang, Tainan City (TW)

(72) Inventor: Yeh-Hsun Wang, Tainan City (TW)

(21) Appl. No.: 15/203,832

(22) Filed: Jul. 7, 2016

(51) Int. Cl. G21H 3/00; G21H 5/00; A41D 31/00

(52) U.S. Cl. CPC G21H 3/00; A41D 31/0033; G21H 5/00; A41D 2400/10; A41D 2400/34; A41D 2400/60; A41D 2400/36

(57) ABSTRACT

A heat keeping structure includes an additive, a first powdered substance and a second powdered substance. The additive and the first powdered substance are mixed to form the second powdered substance which is molded by a spinning device to form the heat keeping structure. The additive includes a radioactive mineral substance, a calcium silicate substance and a halobios calcium which are mixed and treated by a nanotechnology. Thus, the heat keeping structure has radioactive and activating functions, promotes blood circulation and has a heat keeping effect by provision of the radioactive mineral substance. In addition, the heat keeping structure has low thermal conductivity and has a heat storage function by provision of the calcium silicate substance. Further, the heat keeping structure has antibacterial, mildewproof, moisture absorption, deodorizing and anti-static effects by provision of the halobios calcium.

### BACKGROUND OF THE INVENTION

### 1. Field of the Invention

The present invention relates to a heat keeping structure.

### 2. Description of the Related Art

A conventional heat keeping object is made of down feathers. When in use, the heat keeping object is placed in a clothing or bedding to provide an excellent warming effect in the winter. However, the down feathers have a high price, thereby increasing the cost of the heat keeping object. In addition, using the down feathers violates the morality standard and causes an environmental protection problem. Further, the down feathers produce an odor during a long-term utilization, so that the heat keeping object cannot be used for a long time.

### BRIEF SUMMARY OF THE INVENTION

In accordance with the present invention, there is provided a heat keeping structure comprising an additive, a first powdered substance and a second powdered substance. The additive and the first powdered substance are mixed to form the second powdered substance. The second powdered substance is molded by a spinning device to form the heat keeping structure. The additive includes a radioactive mineral substance, a calcium silicate substance and a halobios calcium which are mixed and treated by a nanotechnology.

Preferably, the first powdered substance is made of polyester or nylon.

Preferably, the radioactive mineral substance has a far infrared function and includes a metallic microelement, including zinc, magnesium, nickel, aluminum or silicon.

Preferably, the calcium silicate substance has thermal stability and low thermal conductivity.

Preferably, the radioactive mineral substance and the calcium silicate substance contain a proportion of 10-15% of the additive.

Preferably, the halobios calcium includes processed powder made of a seashell or crustacean.

Preferably, the halobios calcium contain a proportion of 85-90% of the additive.

According to the primary advantage of the present invention, the heat keeping structure has radioactive and activating functions, promotes blood circulation and produces heat energy to have a heat keeping effect by provision of the radioactive mineral substance of the additive.

According to another advantage of the present invention, the heat keeping structure has low thermal conductivity and has a heat storage function by provision of the calcium silicate substance of the additive.

According to a further advantage of the present invention, the heat keeping structure has antibacterial, mildewproof, moisture absorption, deodorizing and anti-static effects by provision of the halobios calcium of the additive.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a block diagram of a heat keeping structure in accordance with the preferred embodiment of the present invention.

FIG. 2 is a figure showing components of an additive of the heat keeping structure in accordance with the preferred embodiment of the present invention.

### DETAILED DESCRIPTION OF THE INVENTION

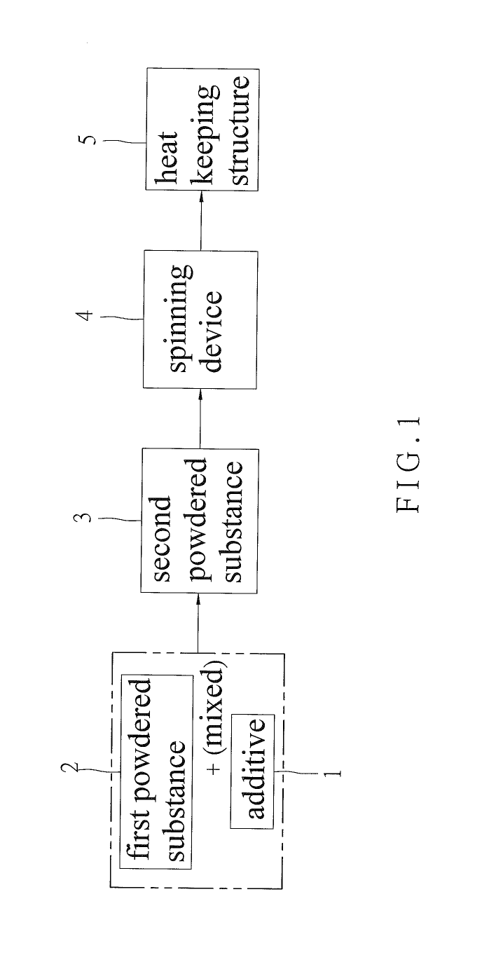

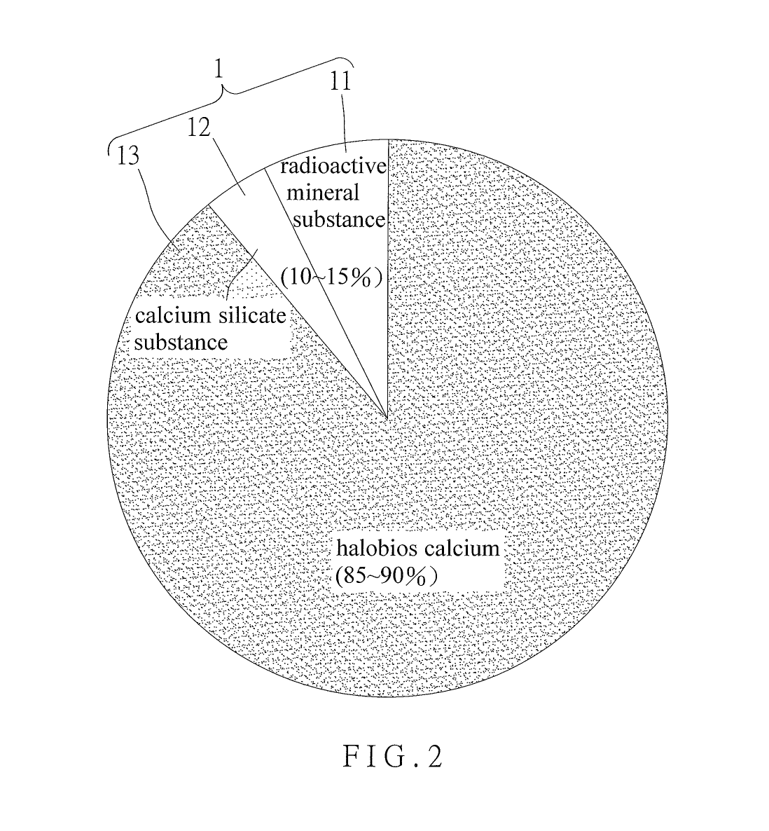

Referring to FIGS. 1 and 2, a heat keeping structure 5 in accordance with the preferred embodiment of the present invention comprises an additive 1, a first powdered substance 2 and a second powdered substance 3. The additive 1 and the first powdered substance 2 are mixed to form the second powdered substance 3. The second powdered substance 3 is molded by a spinning device 4 to form the heat keeping structure 5. The first powdered substance 2 is made of polyester or nylon. The additive 1 includes a radioactive mineral substance 11, a calcium silicate substance 12 and a halobios calcium 13 which are mixed and treated by a nanotechnology. The radioactive mineral substance 11 has a far infrared function and includes a metallic microelement, such as zinc, magnesium, nickel, aluminum, silicon or the like. The calcium silicate substance 12 has thermal stability and low thermal conductivity. The halobios calcium 13 includes processed powder made of a seashell (oyster, clam or the like) or crustacean (shrimp, crab or the like).

In the preferred embodiment of the present invention, the radioactive mineral substance 11 and the calcium silicate substance 12 contain a proportion of 10-15% of the additive 1, and the halobios calcium 13 contain a proportion of 85-90% of the additive 1.

In practice, the heat keeping structure 5 is made to form a cloth product which is available for articles, such as clothes, shoes, socks, gloves, quilts or the like. Alternatively, the heat keeping structure 5 is made to form a packing which is available for an article, such as an overcoat, a bedding or the like. Thus, the heat keeping structure 5 has radioactive and activating functions, promotes blood circulation and produces heat energy to have a heat keeping effect by provision of the radioactive mineral substance 11 of the additive 1.

Besides, the heat keeping structure 5 has low thermal conductivity and has a heat storage function by provision of the calcium silicate substance 12 of the additive 1. Besides, the heat keeping structure 5 has antibacterial, mildewproof, moisture absorption, deodorizing and anti-static effects by provision of the halobios calcium 13 of the additive 1.

Accordingly, the heat keeping structure 5 has radioactive and activating functions, promotes blood circulation and produces heat energy to have a heat keeping effect by provision of the radioactive mineral substance 11 of the additive 1, so as to enhance the value of the first powdered substance 2 made of polyester or nylon which has a low price. In addition, the heat keeping structure 5 has low thermal conductivity and has a heat storage function by provision of the calcium silicate substance 12 of the additive 1 so as to enhance the value of the first powdered substance 2 made of polyester or nylon. Further, the heat keeping structure 5 has antibacterial, mildewproof, moisture absorption, deodorizing and anti-static effects by provision of the halobios calcium 13 of the additive 1 so as to enhance the value of the first powdered substance 2 made of polyester or nylon. Further, the halobios calcium 13 of the additive 1 includes processed powder made of a seashell (oyster, clam or the like) or crustacean (shrimp, crab or the like) so that the heat keeping structure 5 can reuse the wasted material to achieve the purpose of environmental protection. Further, the heat keeping structure 5 replaces down feathers of high prices so that fabrication of the heat keeping structure 5 will not cause a morality problem and can satisfy the requirement of environmental protection. Further, the additive 1 includes the radioactive mineral substance 11, the calcium silicate substance 12 and the halobios calcium 13 which are regarded as wasted material, so that the heat keeping structure 5 reuses the wasted material and has a lower cost of production, thereby greatly decreasing the cost of fabrication. Further, the heat keeping structure 5 replaces down feathers which easily produce odors so that the heat keeping structure 5 has an odorizing effect. Further, the heat keeping structure 5 can keep the temperature so as to overcome the problem of the polyester or nylon which does not have a warming effect.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A heat keeping structure comprising:
an additive, a first powdered substance and a second powdered substance;
wherein:
the additive and the first powdered substance are mixed to form the second powdered substance;
the second powdered substance is molded by a spinning device to form the heat keeping structure; and
the additive includes a radioactive mineral substance, a calcium silicate substance and a halobios calcium which are mixed and treated by a nanotechnology.

2. The heat keeping structure of claim 1, wherein the first powdered substance is made of polyester or nylon.

3. The heat keeping structure of claim 1, wherein the radioactive mineral substance has a far infrared function and includes a metallic microelement, including zinc, magnesium, nickel, aluminum or silicon.

4. The heat keeping structure of claim 1, wherein the calcium silicate substance has thermal stability and low thermal conductivity.

5. The heat keeping structure of claim 1, wherein the radioactive mineral substance and the calcium silicate substance contain a proportion of 10-15% of the additive.

6. The heat keeping structure of claim 1, wherein the halobios calcium includes processed powder made of a seashell or crustacean.

7. The heat keeping structure of claim 1, wherein the halobios calcium contain a proportion of 85-90% of the additive.
